(19) United States
(12) Patent Application Publication
(10) Pub. No.: US 2011/0170255 A1
(43) Pub. Date: Jul. 14, 2011

(54) CARTRIDGE SYSTEM

(75) Inventors: Tomoaki Kouyama, Nagoya-shi (JP); Takayuki Kakuta, Nagoya-shi (JP); Satoru Goto, Nagoya-shi (JP); Shinya Obata, Nagoya-shi (JP); Takashi Ishidoshiro, Nagoya-shi (JP)

(73) Assignee: Buffalo Inc., Nagoya-shi (JP)

(21) Appl. No.: 13/005,785

(22) Filed: Jan. 13, 2011

(30) Foreign Application Priority Data
Jan. 13, 2010 (JP) 2010-005137

(51) Int. Cl. G06F 1/16

(52) U.S. Cl. 361/679.33

(57) ABSTRACT

The cartridge-type HDD 200 to which the operation member 250 is attached is inserted into the slot 150. On this occasion, if in the first placement mode in which the head member 252 is situated on the rear side in the insertion direction of the cartridge-type HDD 200, the operation member 250 does not contact the switch 154. Accordingly, the cartridge-type HDD 200 is in the writable state. On the other hand, if in the second placement mode in which the head member 252 is situated on the front side in the insertion direction of the cartridge-type HDD 200, the operation member 250 presses the switch 154. Accordingly, the cartridge-type HDD 200 is in the write inhibit state.

### CROSS REFERENCE TO RELATED APPLICATION

This application is based upon and claims the benefit of priority from, the prior Japanese Patent Application No. 2010-5137 filed on Jan. 13, 2010; the entire contents of which are incorporated herein by reference.

### BACKGROUND OF THE INVENTION

1. Field of the Invention

This invention relates to a cartridge system which includes a cartridge; and a main body apparatus having a slot into which the cartridge is inserted.

2. Description of the Related Art

Recently, a proposal has been made that a storage medium such as a hard disk drive (HDD) should be used in the form of a cartridge inserted in a main body apparatus such as a reproduction apparatus. There maybe such a cartridges having needs to be settable in a write inhibit state to prevent important data from being erased (for example, Japanese Patent Application Publication No. Hei 8-138307 and Japanese Patent Application Publication No. 2008-21386).

However, the above-described technique has a problem that, while the cartridge-type HDD is inserted in the main body apparatus, the user cannot easily know whether or not the cartridge-type HDD is currently in the write inhibit state.

With this taken into consideration, an object of this invention is to provide a cartridge system which allows a user to easily know whether or not a predetermined operation on a cartridge is enabled.

### SUMMARY OF THE INVENTION

To solve the above-mentioned problem, this invention has the following features. First of all, according to a first feature of this invention, there is provided a cartridge system comprising: a cartridge (cartridge-type HDD 200); a main body apparatus (storage unit main body 100) including a slot (slot 150) into which the cartridge is insertable; an operation member (operation member 250) attached to the cartridge and extending in a direction of insertion of the cartridge into the slot, the operation member being in a first placement mode while a predetermined operation on the cartridge is enabled, and the operation member being in a second placement mode while the predetermined operation on the cartridge is disabled; and an operated part (switch 154) provided inside the main body apparatus, and configured to be operated by the operation member while the cartridge is inserted in the slot and concurrently while the operation member is in any one of the first placement mode and the second placement mode.

In this cartridge system, the operation member attached to the cartridge is in the first placement mode while the predetermined operation on the cartridge is enabled, and is in the second placement mode while the predetermined operation on the cartridge is disabled. Thus, once the cartridge is inserted into the slot, the operated part of the main body apparatus is operated when the operation member is in any one of the first placement mode and the second placement mode. Thereby, from the placement mode of the operation member, the user can know whether or not the predetermined operation on the cartridge is enabled, while the cartridge is inserted in the slot. Furthermore, the main body apparatus is capable of making control in order to permit or inhibit the predetermined operation on the inserted cartridge in response to the operation on the operated part by the operation member, in other words, depending on the placement mode of the operation member.

According to a second feature of this invention, there is provided a cartridge system according to the first feature described above, wherein, while the cartridge is inserted in the slot, the operation member is exposed to an outside in a different manner between the first placement mode and the second placement mode.

According to a third feature of this invention, there is provided a cartridge system according to the first or second feature described above, wherein the operated part is a switch that turns on when pressed by the operation member.

According to a fourth feature of this invention, there is provided a cartridge system according to the first or second feature described above, further comprising a light source (light source 156) provided in any one of the main body apparatus and the cartridge, wherein the operation member is an optically-transparent member.

According to a fifth feature of this invention, there is provided a cartridge system according to the fourth feature described above, wherein a light emitting state of the light source is different depending on a condition of the cartridge.

According to a sixth feature of this invention, there is provided a cartridge system according to the first or second feature described above, wherein the cartridge includes a groove (groove 220) extending in the direction of insertion of the cartridge into the slot, and the operation member is fitted into the groove.

According to a seventh feature of this invention, there is a cartridge system according to the first or second feature described above, wherein the cartridge includes a groove (groove 225) extending in the direction of insertion of the cartridge into the slot, and the operation member is slidable in the groove.

This invention allows the user to easily know whether or not a predetermined operation on a cartridge is enabled.

### BRIEF DESCRIPTION OF THE DRAWINGS

FIG. 1 is a perspective view of an external appearance of an NAS according to an embodiment of this invention.

FIG. 2 is a perspective view of an external appearance of a slot and its vicinity in the NAS according to the embodiment of this invention.

FIG. 3 is a perspective view of an outer appearance of a cartridge-type HDD and a first operation member according to the embodiment of this invention.

FIGS. 4A and 4B are diagrams respectively showing first and second conditions in which the cartridge-type HDD to which the first operation member according to the embodiment of this invention is attached is inserted in the slot of a storage unit main body.

FIGS. 5A and 5B are diagrams respectively showing third and fourth condition in which the cartridge-type HDD to which the first operation member according to the embodiment of this invention is attached is inserted in the slot of the storage unit main body.

FIGS. 6A and 6B are perspective views each showing an outer appearance of a cartridge-type HDD and a second operation member according to another embodiment of this invention.

### DESCRIPTION OF THE EMBODIMENTS

An embodiment of this invention is described below with reference to the drawings. In the following description of the drawings of the embodiment, same or similar reference symbols denote same or similar portions.

It should be noted that the drawings are schematic and the ratios of dimensions are different from actual ones.

Hereinbelow, descriptions will be provided for an embodiment in which a cartridge system according to this invention is applied to an NAS as a network-adaptive storage unit.

The NAS according to the embodiment includes a detachable storage medium. A cartridge using an HDD using a magnetic disc is shown as an example of the storage medium. However, a solid state drive (SSD) using a non-volatile memory or an optical drive may be used instead of the HDD.

Hereinbelow, descriptions will be sequentially provided for (1) a configuration of an NAS, (2) the NAS's conditions in which a cartridge-type HDD is inserted in a slot, (3) operation/working-effect, and (4) other embodiments.

### (1) Configuration of the NAS

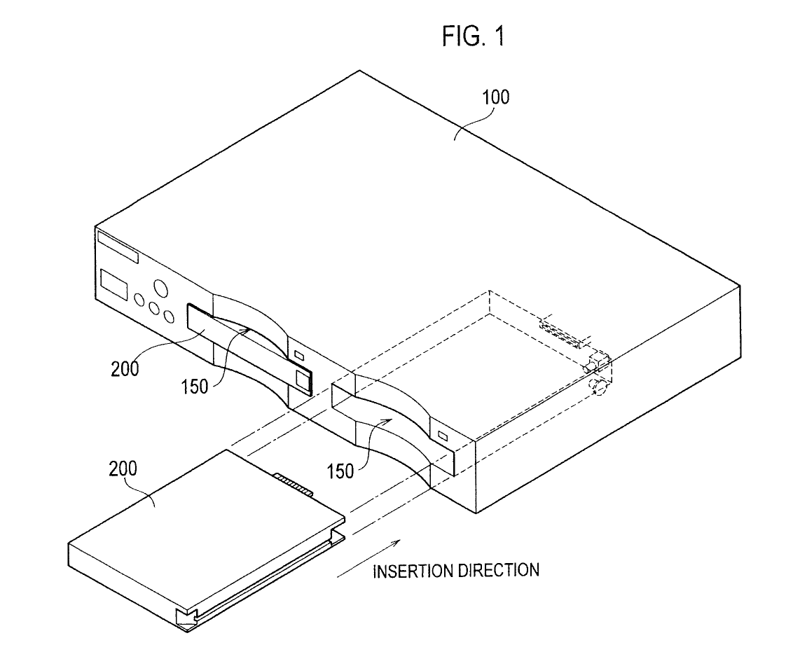

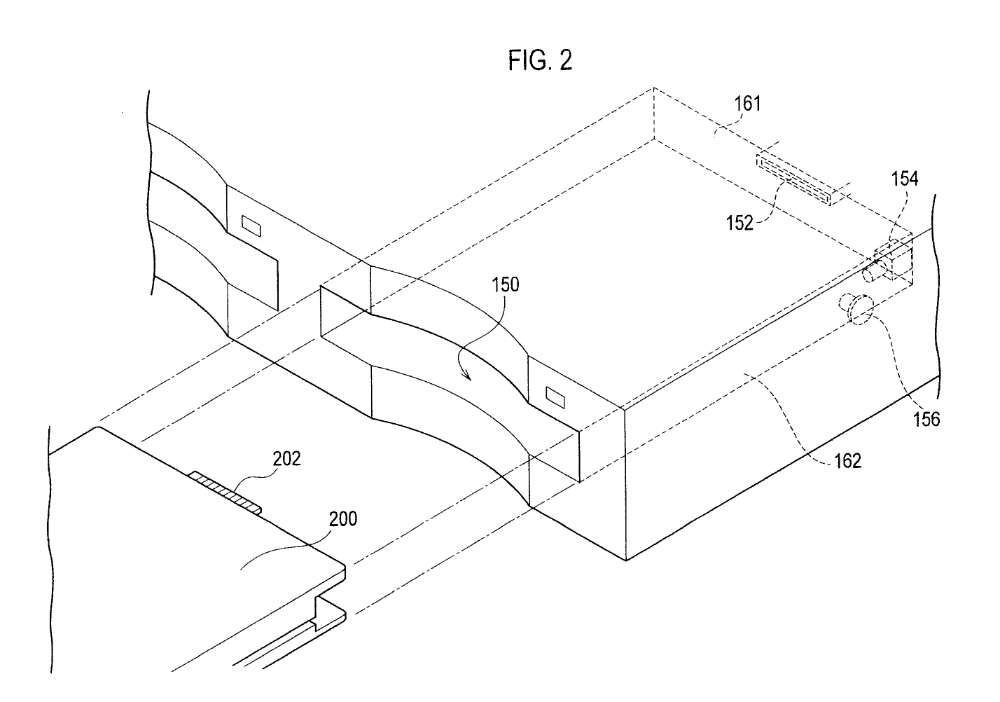

First of all, referring to FIGS. 1 and 2, descriptions will be provided for the overall configuration of the NAS according to the embodiment.

FIG. 1 is a perspective view of an external appearance of the NAS according to the embodiment. FIG. 2 is a perspective illustration of an external appearance of a slot and its vicinity in the NAS according to the embodiment.

In this embodiment, the NAS is comprised of a storage unit main body 100 as a main body apparatus, and a cartridge-type HDD 200 as a cartridge.

The storage unit main body 100 is provided with two slots 150. The cartridge-type HDD 200 is inserted into either of these two slots. Thereby, a connecter 152 provided in the storage unit main body 100 is connected to a connector 202 provided in the cartridge-type HDD 200. Once the connector 152 and the connector 202 are connected together, the storage unit main body 100 gets data read and write and the like ready for being performed on the cartridge-type HDD 200 inserted in the slot 150.

The cartridge-type HDD 200 is that wherein the HDD is housed in the cartridge. The cartridge-type HDD 200 is configured to be detachable from the storage unit main body 100.

Because the cartridge-type HDD 200 is configured to be detachable from the storage unit main body 100, if the cartridge-type HDD 200 runs short of its storage capacity, the recording can be continued by another cartridge-type HDD 200. In addition, the cartridge-type HDD 200 can be properly used depending on the attributes of data to be stored therein.

As shown in FIG. 2, out of the inner wall surfaces of the slot 150, an inner wall surface (first inner wall surface) 161 situated on the front side in an insertion direction of the cartridge-type HDD 200 is provided with a switch 154 in its end portion which is situated in the right when viewed in the insertion direction. In addition, out of the inner wall surfaces of the slot 150, an inner wall surface (second inner wall surface) 162 which extends in the insertion direction of the cartridge-type HDD 200, and which is situated in the right when viewed in the insertion direction, is provided with a light source 156, such as a light-emitting diode (LED), in its position which is situated on the front side in the insertion direction.

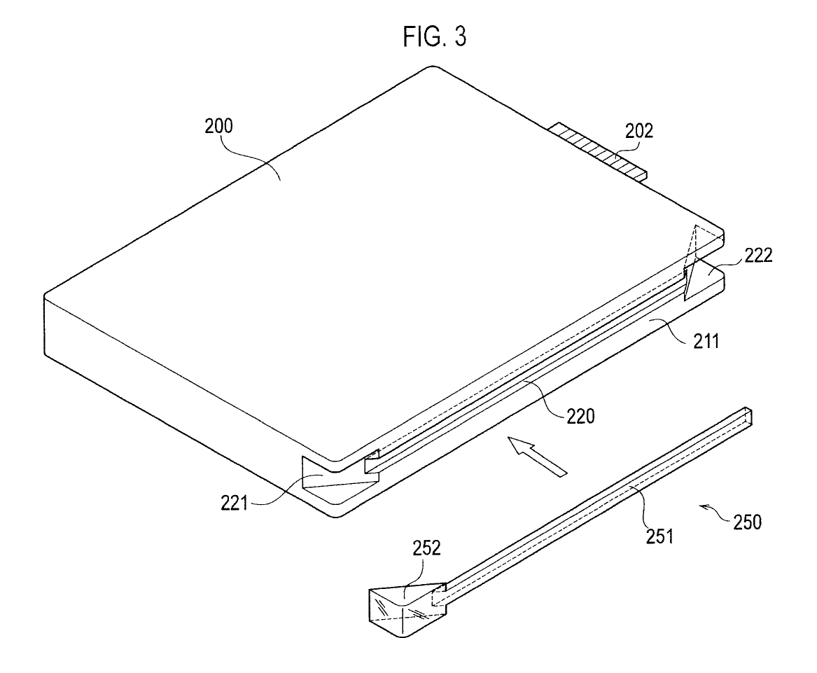

FIG. 3 is a perspective view of an outer appearance of the cartridge-type HDD and a first operation member according to the embodiment of this invention.

As shown in FIG. 3, out of the side surfaces of the cartridge-type HDD 200, a side surface 211 which extends in the insertion direction into the slot 150, and which is situated in the right when viewed in the insertion direction, is provided with a groove 220 which extends in the insertion direction. In addition, the side surface 211 is provided with a notch 221 in its end portion on the rear side in the insertion direction. The side surface 211 is further provided with a notch 222 in its other end portion on the front side in the insertion direction. The notches 221, 222 are formed in the same shape. The groove 220 and the notches 221, 222 constitute a depressed part continuously extending in the side surface 211.

On the other hand, as a first operation member, an operation member 250 is an optically-transparent member made of a transparent resin or the like. This operation member 250 includes a bar-shaped member 251, and a head member 252 attached to one end of the bar-shaped member. The bar-shaped member 251 has a shape corresponding to the groove 220, and the head member 252 has a shape corresponding to the notches 221, 222.

In a placement mode (first placement mode) in which the head member 252 is situated on the rear side in the insertion direction of the cartridge-type HDD 200, the operation member 250 is attached to the cartridge-type HDD 200 with the bar-shaped member 251 engaging with the groove 220, and with the head member 252 engaging with the notch 221.

In a placement mode (second placement mode) in which the head member 252 is situated on the front side in the insertion direction of the cartridge-type HDD 200, the operation member 250 is attached to the cartridge-type HDD 200 with the bar-shaped member 251 engaging with the groove 220, and with the head member 252 engaging with the notch 222.

### (2) NAS's Conditions in Which the Cartridge is Inserted in the Slot

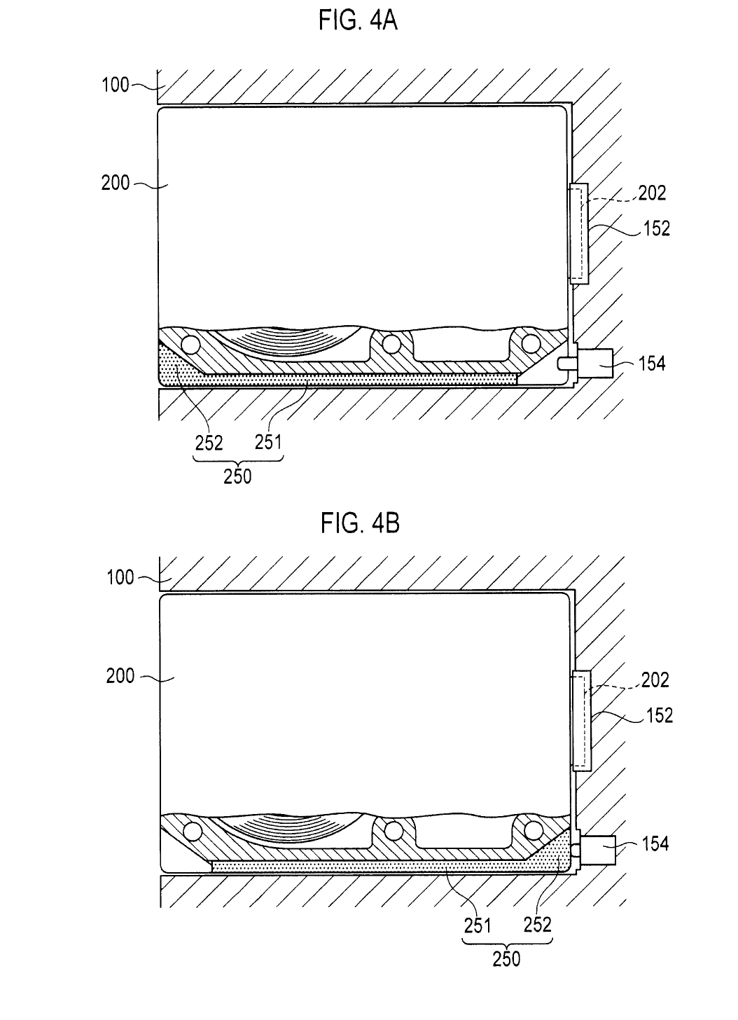

FIGS. 4A and 4B are diagrams respectively showing first and second conditions in which the cartridge-type HDD 200 to which the operation member 250 is attached is inserted in the slot 150 of the storage unit main body.

In the first condition shown in FIG. 4A, the operation member 250 is in the first placement mode in which the head member 252 is situated on the rear side in the insertion direction of the cartridge-type HDD 200. In this case, even when the cartridge-type HDD 200 is inserted into the slot 150, the operation member 250 does not contact the switch 154. For this reason, the switch 154 remains off. When the switch 154 remains off, a controller (not illustrated) inside the storage unit main body 100 puts the cartridge-type HDD 200 in a writable state.

In the second condition shown in FIG. 4B, the operation member 250 is in the second placement mode in which the head member 252 is situated on the front side in the insertion direction of the cartridge-type HDD 200. In this case, when the cartridge-type HDD 200 is inserted into the slot 150, the head member 252 of the operation member 250 contacts and presses the switch 154. Thus, the switch 154 turns on. When the switch 154 is on, a controller (not illustrated) inside the storage unit main body 100 puts the cartridge-type HDD 200 in a write inhibit state.

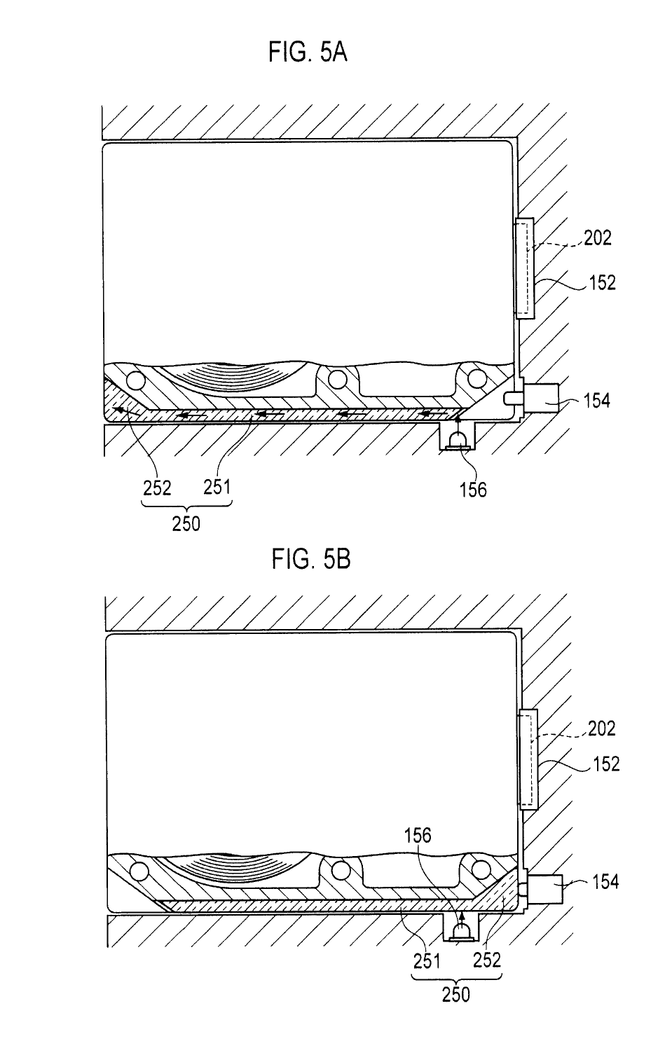

FIGS. 5A and 5B are diagrams respectively showing third and fourth condition in which the cartridge-type HDD 200 to which the operation member 250 is attached is inserted in the slot 150 of the storage unit main body 100.

In the third condition shown in FIG. 5A, the operation member 250 is in the first placement mode in which the head member 252 is situated on the rear side in the insertion direction of the cartridge-type HDD 200. In the fourth condition shown in FIG. 5B, the operation member 250 is in the second placement mode in which the head member 252 is situated on the front side in the insertion direction of the cartridge-type HDD 200.

In any one of the third and fourth conditions, if the cartridge-type HDD 200 is inserted in the slot 150 normally, in other words, if the connector 202 of the cartridge-type HDD 200 is connected to the connector 152 of the storage unit main body 100 normally, the controller (not illustrated) inside the storage unit main body 100 makes the light source 156 emit light. For example, once detecting the electrical conduction between the storage unit main body 100 and the cartridge-type HDD 200, the controller (not illustrated) inside the storage unit main body 100 can determine that the connector 202 and the connector 152 are connected together normally. Once the light source 156 emits light, the light from the light source 156 is radiated to the outside after travelling in the operation member 250 which is the optically-transparent member.

On the other hand, in any one of the third and fourth conditions, if the cartridge-type HDD 200 is not inserted in the slot 150 normally, in other words, if the connector 202 of the cartridge-type HDD 200 is not connected to the connector 152 of the storage unit main body 100 normally, the controller (not illustrated) inside the storage unit main body 100 does not make the light source 156 emit light.

### (3) Operation/Working-Effect

In the above-described NAS, the cartridge-type HDD 200 to which the operation member 250 is attached is inserted into the slot 150. On this occasion, if in the first placement mode in which the head member 252 is situated on the rear side in the insertion direction of the cartridge-type HDD 200, the operation member 250 does not contact the switch 154. Accordingly, the cartridge-type HDD 200 is in the writable state. On the other hand, if in the second placement mode in which the head member 252 is situated on the front side in the insertion direction of the cartridge-type HDD 200, the operation member 250 presses the switch 154. Accordingly, the cartridge-type HDD 200 is in the write inhibit state.

Furthermore, the state of the exposure of the operation member 250 to the outside, specifically, the shape of a portion of the operation member 250 on the rear side in the insertion direction of the cartridge-type HDD 200 is different between the first placement mode of the operation member 250 as shown in FIG. 4A and the second placement mode of the operation member 250 as shown in FIG. 4B. For this reason, from the shape of the portion of the operation member 250 exposed to the outside, the user can easily know whether the cartridge-type HDD 200 is in the writable state or in the write inhibit state.

In addition, in the case where the cartridge-type HDD 200 is inserted in the slot 150 normally, the light source 156 emits light, and the light from the light source 156 is radiated to the outside after travelling in the operation member 250 which is the optically-transparent member. On the other hand, in the case where the cartridge-type HDD 200 is not inserted in the slot 150 normally, the light source 156 emits no light. Thus, from the state of light radiation to the outside through the operation member 250, the user can easily know whether or not the cartridge-type HDD 200 is inserted normally.

### (4) Other Embodiments

As described above, the details of this invention have been disclosed by using the embodiment of this invention. However, it should not be understood that the description and drawings which constitute part of this disclosure limit this invention. From this disclosure, various alternative embodiments, examples, and operation techniques will be easily found by those skilled in the art.

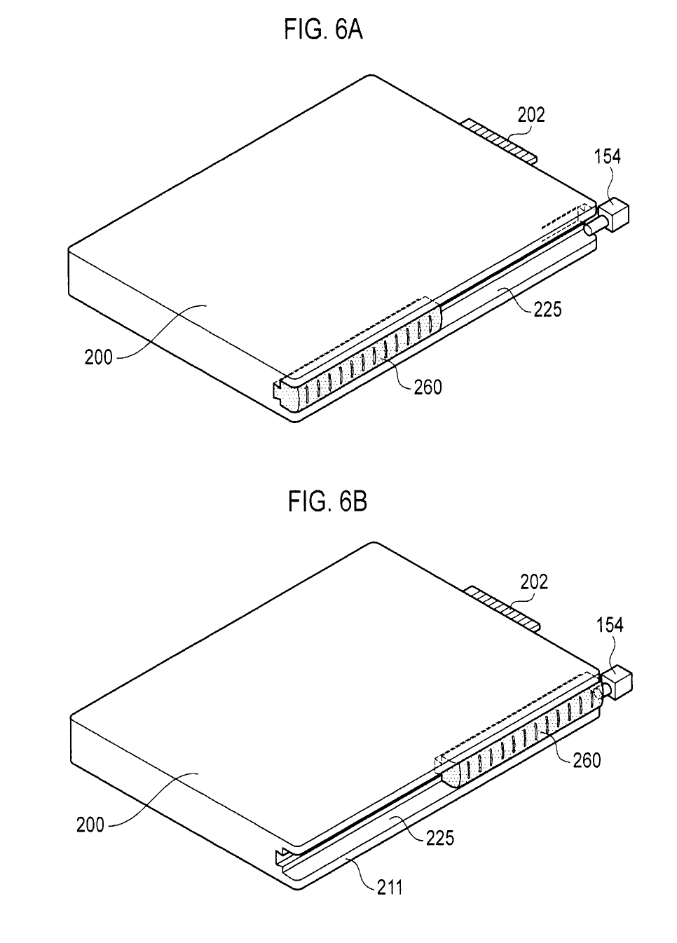

FIGS. 6A and 6B are perspective views each showing an outer appearance of a cartridge-type HDD and a second operation member according to another embodiment of this invention.

As shown in FIGS. 6A and 6B, out of the side surfaces of the cartridge-type HDD 200, the side surface 211 which extends in the insertion direction into the slot 150, and which is situated in the right when viewed in the insertion direction, is provided with a groove 225 which extends in the insertion direction.

On the other hand, as a second operation member, an operation member 260 has a shape corresponding to the groove 225, and is slidable (moving slidingly) in the groove 225.

FIG. 6A shows a placement mode (first placement mode) in which the operation member 260 is situated on the rear side in the insertion direction of the cartridge-type HDD 200. FIG. 6B shows a placement mode (second placement mode) in which the operation member 260 is situated on the front side in the insertion direction of the cartridge-type HDD 200.

In the case of FIG. 6A, even when the cartridge-type HDD 200 is inserted into the slot 150, the operation member 260 does not contact the switch 154. Thus, the switch 154 remains off. When the switch 154 remains off, a controller (not illustrated) inside the storage unit main body 100 puts the cartridge-type HDD 200 in the writable state.

In the case of FIG. 6B, when the cartridge-type HDD 200 is inserted into the slot 150, the operation member 260 contacts and presses the switch 154. Thus, the switch 154 turns on. When the switch 154 turns on, the controller (not illustrated) inside the storage unit main body 100 puts the cartridge-type HDD 200 in the write inhibit state.

As shown in FIG. 6A, while the operation member 260 is in the first placement mode, a portion of the operation member 260 on the rear side in the insertion direction of the cartridge-type HDD 200 is exposed. On the other hand, as shown in FIG. 6B, while the operation member 260 is in the second placement mode, no portion of the operation member 260 is exposed to the outside. Thus, based on whether or not the operation member 250 is exposed to the outside, the user can easily know whether the cartridge-type HDD 200 is in the writable state or in the write inhibit state.

The above-described embodiment allows the user to easily know whether the cartridge-type HDD 200 is in the writable state or in the write inhibit state from on the placement mode of the operation member. However, this invention can be similarly applied to any other operation on the cartridge-type HDD 200 as long as whether the operation is enabled or not is settable by the placement mode of the operation member.

In the above-described embodiment, the light emitting state of the light source 156 is different depending on whether or not the cartridge-type HDD 200 is inserted in the slot 150 normally. Nevertheless, the light emitting state of the light source 156 may be different depending on any other condition of the cartridge-type HDD 200 instead of the condition of the insertion of the cartridge-type HDD 200 in the slot 150.

For example, the light emitting state of the light source 156 may be different depending on a condition of access to the cartridge-type HDD 200, such as the write to the cartridge-type HDD 200 and the read from the cartridge-type HDD 200. Furthermore, the light emitting state of the light source 156 may be different depending on whether or not the write to the cartridge-type HDD 200 is enabled. Moreover, the light emitting state of the light source 156 may be different depending on a communication condition, such as a speed of communications between the storage unit main body 100 and the cartridge-type HDD 200.

Further, in the above-described embodiment, the light source 156 is provided in the storage unit main body 100. Instead, the light source 156 may be provided in a portion of the cartridge-type HDD 200 on the front side in the insertion direction of the cartridge-type HDD 200. In this case, the light from the light source 156 provided in the cartridge-type HDD 200 can be radiated to the outside after travelling in the operation member 250.

In addition, in the above-described embodiment, the groove 220 in the side surface 211 of the cartridge-type HDD 200 extends straightly in the direction in which the cartridge-type HDD 200 is inserted into the slot 150. However, the shape of the groove 220 in its extension direction is not limited to this. For example, the shape of the groove 220 in its extension direction may be shaped like a waveform.

As described above, this invention naturally includes various embodiments which are not described herein. Accordingly, the technical scope of this invention should be determined only by the matters to define the invention in the scope of claims regarded as appropriate based on the description.

The cartridge system according to the present allows the user to easily know whether or not a predetermined operation on the cartridge is enabled, and is accordingly useful as a cartridge system.

What is claimed is:

1. A cartridge system comprising:
a cartridge;
a main body apparatus including a slot into which the cartridge is insertable;
an operation member attached to the cartridge and extending in a direction of insertion of the cartridge into the slot, the operation member being in a first placement mode while a predetermined operation on the cartridge is enabled, and the operation member being in a second placement mode while the predetermined operation on the cartridge is disabled; and
an operated part provided inside the main body apparatus, and configured to be operated by the operation member while the cartridge is inserted in the slot and concurrently while the operation member is in any one of the first placement mode and the second placement mode.

2. The cartridge system according to claim 1, wherein, while the cartridge is inserted in the slot, the operation member is exposed to an outside in a different manner between the first placement mode and the second placement mode.

3. The cartridge system according to claims 1, wherein the operated part is a switch that turns on when pressed by the operation member.

4. The cartridge system according to claims 1, further comprising
a light source provided in any one of the main body apparatus and the cartridge, wherein
the operation member is an optically-transparent member.

5. The cartridge system according to claim 4, wherein a light emitting state of the light source is different depending on a condition of the cartridge.

6. The cartridge system according to claims 1, wherein
the cartridge includes a groove extending in the direction of insertion of the cartridge into the slot, and
the operation member is fitted into the groove.

7. The cartridge system according to claims 1, wherein
the cartridge includes a groove extending in the direction of insertion of the cartridge into the slot, and
the operation member is slidable in the groove.
